(19) United States
(12) Patent Application Publication
(10) Pub. No.: US 2026/0092527 A1
(43) Pub. Date: Apr. 2, 2026

(54) INTELLIGENT AUTOMATIC COAL POWDER RECEIVING DEVICE AND METHOD BASED ON PREVENTION AND CONTROL OF ROCK BURSTS IN COAL MINES

(71) Applicant: Shandong University of Science and Technology, Qingdao (CN)

(72) Inventors: Pu WANG, Qingdao (CN); Mei ZHANG, Qingdao (CN); Chuanyang ZHANG, Qingdao (CN); Zesheng WEI, Qingdao (CN); Huidan CHEN, Qingdao (CN)

(73) Assignee: Shandong University of Science and Technology, Qingdao (CN)

(21) Appl. No.: 18/966,181

(22) Filed: Dec. 3, 2024

(30) Foreign Application Priority Data
Sep. 29, 2024 (CN) 202411372695.6

(51) Int. Cl. E21F 5/20; F15B 11/16; F15B 15/16; F15B 19/00; G05D 1/249; G05D 1/648; G05D 109/10

(52) U.S. Cl. CPC E21F 5/20; F15B 11/16; F15B 15/16; F15B 19/00; G05D 1/249; G05D 1/648; G05D 2109/10

(57) ABSTRACT

An intelligent automatic coal powder receiving device based on prevention and control of rock burst in coal mines includes a driving vehicle. Wheels with a moving function and a central processor are set on the driving vehicle, supporting mechanisms are set symmetrically on both sides of the driving vehicle, a coal powder storage box and a cross double frame positioning mechanism are set at the top of the driving vehicle, a coal powder receiving pipe is set on the cross double frame positioning mechanism, a binocular camera is set at the coal powder receiving pipe, and one end of the coal powder receiving pipe is a coal powder inlet, the other end of the coal powder receiving pipe is connected to the coal powder storage box through a connecting pipe, and the cross double frame positioning mechanism is connected to the driving vehicle through a telescopic mechanism.

### CROSS REFERENCE TO THE RELATED APPLICATIONS

This application is based upon and claims priority to Chinese Patent Application No. 202411372695.6, filed on Sep. 29, 2024, the entire contents of which are incorporated herein by reference.

### TECHNICAL FIELD

The invention relates to the technical field of prevention and control of rock bursts in coal mines, in particular to an intelligent automatic coal powder receiving device and a method based on prevention and control of rock bursts in coal mines.

### BACKGROUND

Rock burst in coal mines, also known as rock burst, is a kind of dynamic disaster in coal mining, the prevention and control of coal powder receiving mainly refers to the process of receiving the coal powder brought out by the drilling bit during the drilling process of the drilling rig, the drilling rig is often used with the coal powder receiving device, how to safely and effectively receive the coal powder brought out by the drilling rig is an important problem in the field of prevention and control of rock bursts in coal mines.

In the existing technology, the patent CN118547991 A discloses a coal powder receiving device for rock burst in coal mines prevention and monitoring boreholes, including a movable base, the top of the base is provided with a positioning component for drilling positioning processing, the bottom of the base is provided with a fastening component for improving the stability of the receiving device, the top of the base is provided with a driving component for extending the positioning component and the fastening component. Through the setting of the driving component, the coal powder receiving device of the rock burst in coal mines prevention and monitoring borehole can not only drive the positioning component to expand and contract, but also drive the tightening component to expand and contract, it has good linkage function, which not only reduces the use of additional electric driving source, but also ensures that the tightening component can ensure the stability of the whole equipment in real-time when the positioning component is positioning the borehole, improve the collection effect of the positioning component on the coal powder generated during the drilling, and prevent the problem of coal powder falling. However, the above device still needs to be manually driven to move as a whole, unable to automatically locate and collect coal powder, with low intelligence and inconvenient operation. At the same time, it increases labor costs, harms workers, and is extremely inconvenient.

### SUMMARY

In order to solve the problems in the above background technology, the purpose of this invention is to provide an intelligent automatic coal powder receiving device and a method based on prevention and control of rock bursts in coal mines. Through a variety of sensors with the central processor, the automatic positioning and automatic receiving of coal powder is realized, it is more intelligent and easy to operate, the labor costs are reduced and the safety of workers is guaranteed, it is more convenient.

In order to achieve the above purpose, the invention provides an intelligent automatic coal powder receiving device based on prevention and control of rock burst in coal mines, including a driving vehicle, wheels with a moving function are set on the driving vehicle, a central processor is set in the driving vehicle, supporting mechanisms with a flipping and retracting function are set symmetrically on both sides of the driving vehicle, a coal powder storage box and a cross double frame positioning mechanism are set at the top of the driving vehicle, a coal powder receiving pipe is set on the cross double frame positioning mechanism, a binocular camera is set at the coal powder receiving pipe, and one end of the coal powder receiving pipe is a coal powder inlet, the other end of the coal powder receiving pipe is connected to the coal powder storage box through a connecting pipe, and the cross double frame positioning mechanism is connected to the driving vehicle through a telescopic mechanism.

Preferably, a center of the wheel is provided with a first infrared sensor, the first infrared sensor is used to detect a distance between the wheel and the ground; the connecting pipe includes a first connecting pipe and a second connecting pipe, the first connecting pipe is a hose, one end of the first connecting pipe is connected to the coal powder receiving pipe, the other end of the first connecting pipe is connected to a vacuuming element, the vacuuming element is connected to an interior of a powder storage box through the second connecting pipe.

Preferably, the supporting mechanism includes a fixed plate, a top of the fixed plate is provided with a first electric hydraulic cylinder, a hydraulic rod of the first electric hydraulic cylinder runs through the fixed plate and connects to a top of a supporting plate, one side of the fixed plate is connected to a side of the driving vehicle, the fixed plate is connected to a top of the driving vehicle through a rotating structure.

Preferably, both ends of the fixed plate and front and rear ends of the driving vehicle are equipped with a sensor box, the sensor box is equipped with a visual sensor, the sensor box is equipped with a second infrared sensor, the visual sensor is used to detect an obstacle at the front and rear ends and left and right sides of the driving vehicle, the second infrared sensor is used to detect a distance between the driving vehicle and the obstacle.

Preferably, the rotating structure includes a fixed block set at the top of the driving vehicle, and a second electric hydraulic cylinder is set on the fixed block, a hydraulic rod of the second electric hydraulic cylinder is hinged with the top of the fixed plate, and a bottom of the second electric hydraulic cylinder is hinged with the fixed block, pressure sensors are arranged on both sides of the driving vehicle corresponding to a position of the fixed plate, the pressure sensor is used to detect a pressure between the fixed plate and the driving vehicle.

Preferably, the cross double frame positioning mechanism includes a first frame and a second frame, four corners of the first frame are connected to four corners of the second frame through a connecting column, and the first frame is connected to the telescopic mechanism through a fixed column, the first frame is equipped with a longitudinal movement adjustment structure, and the second frame is equipped with a lateral movement adjustment structure.

Preferably, the longitudinal movement adjustment structure includes two first screws, the first screw is sleeved with a first moving seat, one end of the coal powder receiving pipe is arranged on the first moving seat, the first screw is connected to the first moving seat through a thread, a top of the first frame is provided with an upper opening, a bottom is provided with a lower opening, a first sliding seat is movably set in the upper opening, a second sliding seat is movably set in the lower opening, the first servo motor is provided on the first sliding seat, an output shaft of the first servo motor is connected to one end of the first screw, and the other end of the first screw is in a rotary connection with the second sliding seat;
the lateral movement adjustment structure includes two second screws, the second screw is sleeved with a second moving seat, the other end of the coal powder receiving pipe is set on the second moving seat, and the second screw is connected to the second moving seat through the thread, one side of the first frame is provided with a left opening, and the other side is provided with a right opening, a third sliding seat is movably set in the left opening, a fourth sliding seat is movably set in the right opening, a second servo motor is provided on the third sliding seat, an output shaft of the second servo motor is connected to one end of the second screw, and the other end of the second screw is in the rotary connection with the fourth sliding seat; the binocular camera is set on the second moving seat.

Preferably, the telescopic mechanism includes a sliding body set on the driving vehicle, and a lower part of the sliding body is slidingly connected to an inner side of the fixed block, the coal powder storage box is equipped with a third electric hydraulic cylinder, and a hydraulic cylinder rod of the third electric hydraulic cylinder is connected to one end of the sliding body.

Preferably, a double-shaft cylinder is arranged below the coal powder receiving pipe, and the double-shaft cylinder is arranged on the cross double frame positioning mechanism, a cylinder rod of the double-shaft cylinder is connected to one end of a collection box, the other end of the collection box is provided with an arc opening, the arc opening is connected with an inclined collecting shovel, the inclined collecting shovel is used to collect the coal powder extracted from a drilling rig.

The invention also provides a receiving method for the intelligent automatic coal powder receiving device based on prevention and control of rock bursts in coal mines, including the following steps:
Step 1, driving the driving vehicle to a target location by the wheels, and using the visual sensor and the infrared sensor to avoid an obstacle during a movement;
Step 2, detecting a distance between the driving vehicle and a drilling position of the drilling rig by the second infrared sensor and the binocular camera, and adjusting a position of the driving vehicle;
Step 3, after the position of the driving vehicle is well adjusted, driving the fixed plate to rotate by the second electric hydraulic cylinder to expand the fixed plate, after the pressure sensor reaches a set pressure, stopping the second electric hydraulic cylinder, driving the support plate to drop by the first electric hydraulic cylinder to support the driving vehicle, after the infrared sensor detects that a distance between a wheel center and the ground is greater than a set distance, stopping the first electric hydraulic cylinder stops.
Step 4, detecting a position of the drilling rig by the binocular camera to complete an initial positioning, firstly, driving the first screw to rotate by the first servo motor to drive the first moving seat to move on the first screw and adjust a position of the first moving seat; then driving the second screw to rotate by the second servo motor to drive the second moving seat to move on the second screw and adjust a position of the second moving seat, so as to adjust longitudinal positions and lateral positions of the coal powder receiving pipes on the first moving seat and the second moving seat, so that the coal powder receiving pipe moves to the drilling position of the drilling rig.
Step 5, detecting the drilling position of the drilling rig again through the binocular camera to complete a secondary positioning, starting the first servo motor and the second servo motor again to adjust a position of the coal powder receiving pipe, after an adjustment is completed, driving the sliding body to slide forward by the third electric hydraulic cylinder, driving the fixed column to slide by the sliding body, and then driving the whole cross double frame positioning mechanism to advance, so that the coal powder inlet of the coal powder receiving pipe is close to the drilling position of the drilling rig.
Step 6, starting the vacuuming element, and the coal powder enters the coal powder storage box through the coal powder receiving pipe, the first connecting pipe, the vacuuming element, and the second connecting pipe in turn to complete a coal powder receiving.

Therefore, the invention adopts the above-mentioned intelligent automatic coal powder receiving device and method based on prevention and control of rock bursts in coal mines, which has the following beneficial effects:
(1) The invention makes the wheel leave the ground through the support plate of the support mechanism, which increases the stability of the device during operation; the support mechanism is retracted by a flipping fixed plate to save space, and the pressure sensor can detect the pressure on the side of the fixed plate and the side of the driving vehicle, so that the support mechanism can automatically stop after the flipping is completed, through the infrared sensor with the visual sensor, the driving vehicle avoids obstacles without manually pushing to ensure the personal safety of the staff;
(2) The invention realizes the longitudinal and lateral movement of the coal powder receiving pipe through the double frame of the cross double frame positioning mechanism and the servo motor screw structure, so as to realize the positioning of the coal powder receiving pipe and make it more convenient to use;
(3) The invention realizes automatic positioning and automatic receiving of coal powder through a variety of sensors with the central processor, which is more intelligent and easy to operate, the labor costs are reduced and the safety of workers is guaranteed, it is more convenient.

The following is a further detailed description of the technical scheme of the invention through drawings and embodiments.

### BRIEF DESCRIPTION OF THE DRAWINGS

FIG. 1 is a stereogram of the device of the embodiment of the invention;

FIG. 2 is a left view of the device of the embodiment of the invention;

FIG. 3 is a right view of the device of the embodiment of the invention;

FIG. 4 is a schematic diagram of the rotating structure of the embodiment of the invention;

FIG. 5 is a schematic diagram of the slider and chute structure of the embodiment of the invention;

FIG. 6 is a schematic diagram of the collecting shovel structure of the embodiment of the invention.

### MARKS IN THE FIGURES

1, driving vehicle; 2, wheel; 3, coal powder storage box; 4, coal powder receiving pipe; 5, the first infrared sensor; 6, the second infrared sensor; 7, the first connecting pipe; 8, the second connecting pipe; 9, vacuuming element; 10, fixed plate; 11, the first electric hydraulic cylinder; 12, the second electric hydraulic cylinder; 13, the third electric hydraulic cylinder; 14, support plate; 15, sensor box; 16, visual sensor; 17, fixed block; 18, pressure sensor; 19, the first frame; 20, the second frame; 21, the first servo motor; 22, the first screw; 23, the first moving seat; 24, the first sliding seat; 25, the second sliding seat; 26, the second servo motor; 27, the second screw; 28, the second moving seat; 29, the third sliding seat; 30, the four sliding seat; 31, binocular camera; 32, fixed column; 33, connecting column; 34, sliding body; 35, slider; 36, chute; 37, double-shaft cylinder; 38, collection box; 39, arc opening; 40, collecting shovel.

### DETAILED DESCRIPTION OF THE EMBODIMENTS

In order to make the purpose, technical scheme, and advantages of the disclosure of the embodiments of the invention more clear, the embodiments of the invention are further described in detail in combination with the attached drawings and embodiments. It should be understood that the specific embodiments described here are only used to explain the embodiments of the invention, and are not used to limit the embodiments of the invention. Based on the embodiments in this application, all other embodiments obtained by ordinary technical personnel in this field without making creative work belong to the scope of protection in this application. Examples of the embodiments are shown in the accompanying figures, where the same or similar labels from beginning to end represent the same or similar components or components with the same or similar functions.

It should be noted that the terms include and have and any deformation of them are intended to cover non-exclusive inclusion, for example, a process, method, system, product, or server that contains a series of steps or units need not be limited to those steps or units that are clearly listed, but may include other steps or units that are not clearly listed or are inherent to those processes, methods, products or equipment.

Similar labels and letters represent similar items in the following figures. Therefore, once an item is defined in a figure, it does not need to be further defined and explained in the subsequent figures.

In the description of the invention, it is necessary to explain that the orientation or positional relationship indicated by the terms up, down, inside, outside, etc. is based on the orientation or positional relationship shown in the attached figures, or is the orientation or positional relationship that is habitually placed when the invention product is used, only to facilitate the description of the invention and simplify the description, rather than to indicate or imply that the device or component referred to must have a specific orientation, be constructed and operated in a specific orientation, and therefore cannot be understood as a limitation to the invention.

In the description of the invention, it is also necessary to explain that, unless otherwise clearly defined and limited, the terms set, install, and connect should be understood in a broad sense. For example, it can be a fixed connection, a detachable connection, or an integrated connection; it can be a mechanical connection or electrical connection; it can be directly connected or indirectly connected through an intermediate medium, which can be the internal connection of two components. For ordinary technicians in this field, the specific meaning of the above terms in this invention can be understood in detail.

### Embodiment 1

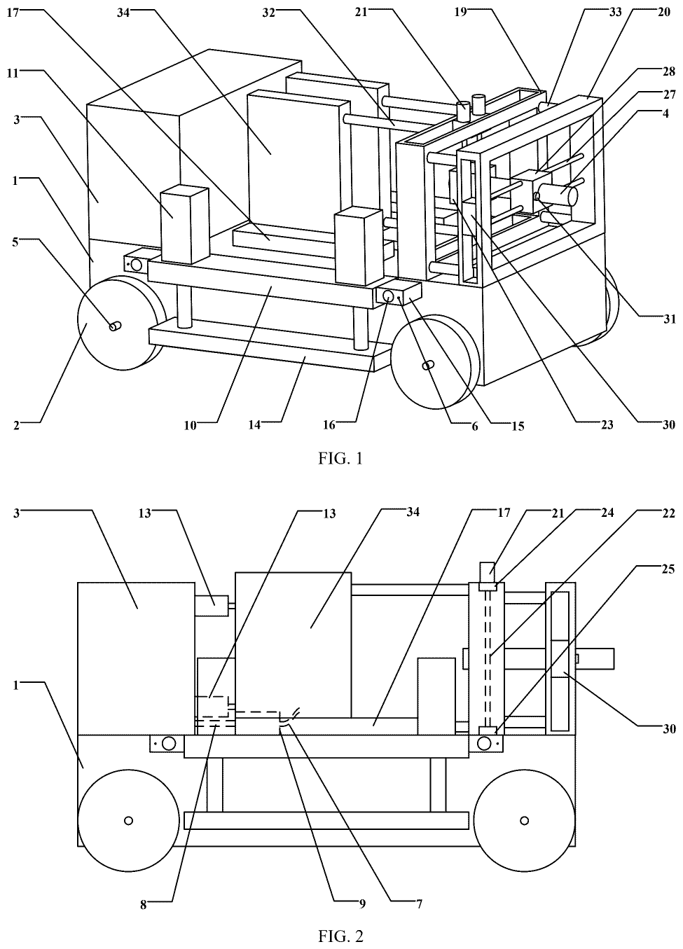

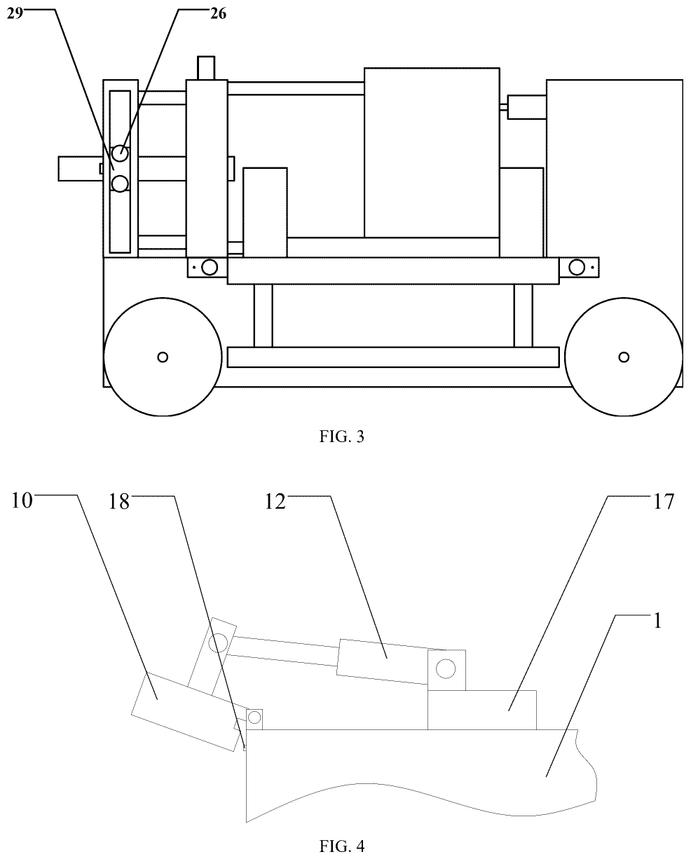

As shown in FIGS. 1-3, an intelligent automatic coal powder receiving device based on the prevention and control of rock bursts in coal mines is described in the invention, including a driving vehicle 1, the driving vehicle 1 is equipped with wheels 2 with moving function, and driving vehicle 1 is equipped with a central processor. The driving vehicle 1 is equipped with a driving mechanism that drives the wheel 2 to move and steer, the driving mechanism adopts the existing structure and is controlled by the central processor, thus the movement of the driving vehicle 1 is controlled. A positioning sensor is also arranged in the driving vehicle 1 to determine the position of the device, the center of wheel 2 is equipped with the first infrared sensor 5, and the first infrared sensor 5 is used to detect the distance between wheel 2 and the ground.

The connecting pipe includes the first connecting pipe 7 and the second connecting pipe 8, the first connecting pipe 7 is a hose, one end of the first connecting pipe 7 is connected to the coal powder receiving pipe 4, and the other end of the first connecting pipe 7 is connected to the vacuuming element 9, the vacuuming element 9 is connected to the interior of the powder storage box through the second connecting pipe 8, the vacuuming element 9 adopts the existing structure, and the coal powder is transported to the coal powder storage box 3 through a motor and a fan.

The two sides of the driving vehicle 1 are symmetrically arranged with the supporting mechanisms with a flipping and retracting function, the supporting mechanism includes a fixed plate 10, and the top of the fixed plate 10 is equipped with two first electric hydraulic cylinders 11, the hydraulic rod of the first electric hydraulic cylinder 11 runs through the fixed plate 10 and connects to the top of the support plate 14, one side of the fixed plate 10 is connected to the side of the driving vehicle 1, and the fixed plate 10 is connected to the top of the driving vehicle 1 through the rotating structure. As shown in FIG. 4, the rotating structure includes a fixed block 17 set at the top of the driving vehicle 1, and two second electric hydraulic cylinders 12 are set on the fixed block 17. The hydraulic rod of the second electric hydraulic cylinder 12 is hinged with the top of the fixed plate 10, and the bottom of the second electric hydraulic cylinder 12 is hinged with the fixed block 17. Both ends of the fixing plate 10 and the front and rear ends of the driving vehicle 1 are equipped with sensor boxes 15, the sensor box 15 is equipped with a visual sensor 16, and the sensor box 15 is equipped with the second infrared sensor 6. The visual sensor 16 is used to detect the obstacles at the front and rear ends and the obstacles at the left and right sides of the driving vehicle 1, the second infrared sensor 6 is used to detect the distance between the driving vehicle 1 and the obstacle. The pressure sensors 18 are set on both sides of the driving vehicle 1 corresponding to the position of the fixed plate 10, and the pressure sensor 18 is used to detect the pressure between the fixed plate 10 and the driving vehicle 1.

The hydraulic rod of the first electric hydraulic cylinder 11 can drive the support plate 14 to move down and lift the driving vehicle 1, so the wheels 2 will leave the ground, and the stability of the device is improved during operation. At the bottom of the support plate 14, a rubber pad with lines or particles or a small conical fixed nail can be set to further improve the stability of the connection between the support plate 14 and the ground. The hydraulic rod of the first electric hydraulic cylinder 11 can drive the fixed plate 10 to rotate upward, so that the supporting mechanism on both sides shrinks inward, reducing the occupied space when not in use. When the fixed plate 10 is flipped upward, the second electric hydraulic cylinder 12 is also flipped to the top of the driving vehicle 1, and the driving vehicle 1 is provided with enough space to accommodate the second electric hydraulic cylinder 12.

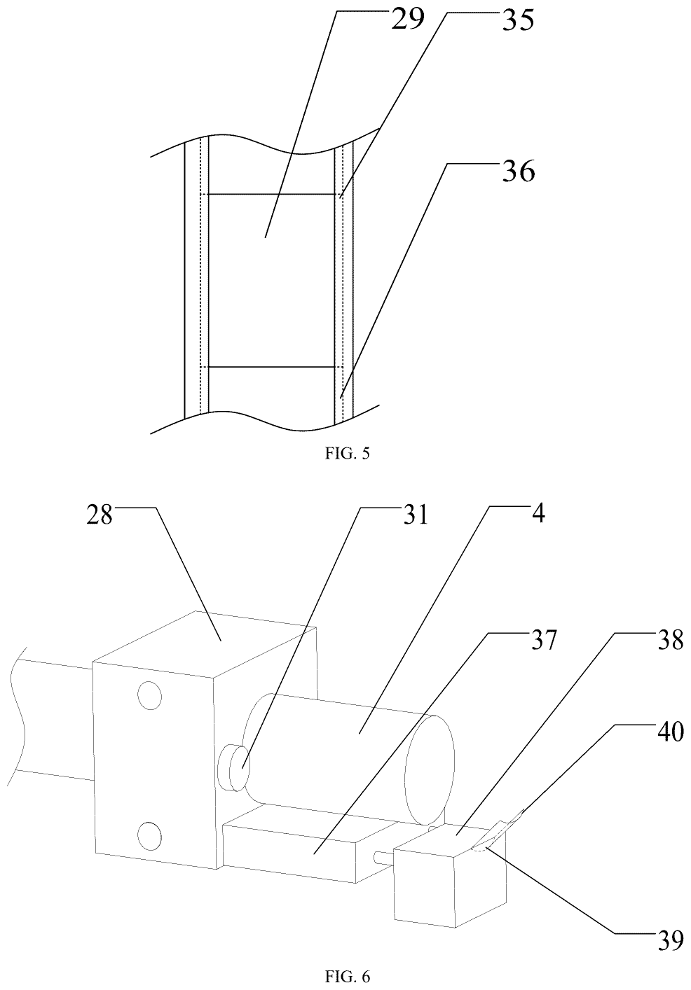

The top of the driving vehicle 1 is equipped with a coal powder storage box 3 and a cross double frame positioning mechanism. The cross double frame positioning mechanism is equipped with a coal powder receiving pipe 4, and the coal powder receiving pipe 4 is equipped with a binocular camera 31. One end of the coal powder receiving pipe 4 is the coal powder inlet, and the other end of the coal powder receiving pipe 4 is connected to the coal powder storage box 3 through the connecting pipe. The cross double frame positioning mechanism includes the first frame 19 and the second frame 20. The four corners of the first frame 19 are connected with the four corners of the second frame 20 through the connecting column 33, and the first frame 19 is connected with the telescopic mechanism through the fixed column 32. The longitudinal movement adjustment structure is set on the first frame 19, and the lateral movement adjustment structure is set on the frame 20. The longitudinal movement adjustment structure includes two first screws 22, the first screw 22 is equipped with a first moving seat 23, one end of the coal powder receiving pipe 4 is set on the first moving seat 23, and the first screw 22 is connected with the first moving seat 23 through a thread, the top of the first frame 19 is provided with an upper opening, and the bottom is provided with a lower opening, the first sliding seat 24 is set in the upper opening, and the second sliding seat 25 is set in the lower opening, the first servo motor 21 is set on the first sliding seat 24, the output shaft of the first servo motor 21 is connected with one end of the first screw 22, and the other end of the first screw 22 is in a rotary connection with the second sliding seat 25. The lateral movement adjustment structure includes two second screws 27, the second screw 27 is set with the second moving seat 28, the other end of the coal powder receiving pipe 4 is set on the second moving seat 28, and the second screw 27 is connected with the second moving seat 28 through a thread. One side of the first frame 19 is provided with a left opening, the other side is provided with a right opening, the left opening is provided with a third sliding seat 29, and the right opening is provided with a fourth sliding seat 30. A second servo motor 26 is set on the third sliding seat 29, an output shaft of the second servo motor 26 is connected with one end of the second screw 27, and the other end of the second screw 27 is in the rotary connection with the fourth sliding seat 30. The binocular camera 31 is set on the second moving seat 28 and is located on both sides of the coal powder receiving pipe 4. As shown in FIG. 5, sliders 35 are set on both sides of the first sliding seat 24, the second sliding seat 25, the third sliding seat 29, and the fourth sliding seat 30, the corresponding openings are provided with chutes 36 that are compatible with the sliders 35, the slider 35 is inserted in the chute 36 and slidingly connected with the chute 36. The slider 35 chute 36 structure makes the sliding seats not fall out from their respective openings.

The output shafts of the two first servo motors 21 drive the respective first screw 22 to rotate, so that the first moving seat 23 moves up and down on the first screw 22, thereby driving the coal powder receiving pipe 4 to move longitudinally; the output shafts of the two second servo motors 26 respectively drive the respective second screw 27 to rotate, so that the second moving seat 28 moves around the second screw 27, thus driving the coal powder receiving pipe 4 to move laterally, and completing the adjustment of the longitudinal and lateral positions of the coal powder receiving pipe 4. Because the first servo motor 21 and the second servo motor 26 are installed on their respective sliding seats, the sliding seats and the openings are slidingly set, when the first servo motor 21 drives the first moving seat 23 to move longitudinally, the second servo motor 26 will also move longitudinally with the sliding seat in the opening, when the second servo motor 26 drives the second moving seat 28 to move laterally, the first servo motor 21 will also move laterally with the sliding seat in the opening, which will not affect the adjustment of the lateral and longitudinal positions of the coal powder receiving pipe 4.

The cross double frame positioning mechanism is connected with the driving vehicle 1 through the telescopic mechanism. The telescopic mechanism includes a sliding body 34 slidingly set on the driving vehicle 1, and the lower part of the sliding body 34 is slidingly connected to the inner side of the fixed block 17. There are four fixed rods, one end of the fixed rod is connected with the first frame 19, and the other end of the fixed rod is fixed with the sliding body 34. The coal powder storage box 3 is equipped with the third electric hydraulic cylinder 13, and the hydraulic cylinder rod of the third electric hydraulic cylinder 13 is connected with one end of the sliding body 34. The hydraulic rod of the third electric hydraulic cylinder 13 can drive the sliding body 34 to move forward or backward, so as to drive the whole cross double frame positioning mechanism to move forward or backward. The bottom of the cross double frame positioning mechanism is slidingly connected with the top of the driving vehicle 1. The fixed block 17 has a guiding effect on the sliding of the sliding body 34 and makes the sliding body 34 slide more stable. The first connecting pipe 7 is long enough to not affect the lateral, longitudinal, and telescopic movement of the coal powder receiving pipe 4.

The central processor adopts the existing Qualcomm Snapdragon 8295 chip, which has strong performance, low power consumption, and small size. The driving mechanism of the driving vehicle 1, the first electric hydraulic cylinder 11, the second electric hydraulic cylinder 12, the third electric hydraulic cylinder 13, the first servo motor 21, the second servo motor 26, the visual sensor 16, the first infrared sensor 5, the second infrared sensor 6, the binocular camera 31 and the central processor are electronically connected by the existing structure, and the central processor is connected to the PC terminal by the existing wireless communication module.

The invention also provides a receiving method for the intelligent automatic coal powder receiving device based on prevention and control of rock bursts in coal mines, including the following steps:
Step 1, the driving vehicle 1 is controlled through the PC terminal with the central processor, the wheel 2 is controlled to drive the driving vehicle 1 to move the target location, the obstacles are detected and avoided through the visual sensor 16 and infrared sensor during the movement process;
Step 2, the distance between the driving vehicle 1 and the drilling position of the drilling rig is detected by the second infrared sensor 6 and the binocular camera 31, and the position of the driving vehicle 1 is adjusted;
Step 3, after the position of the driving vehicle 1 is well adjusted, the second electric hydraulic cylinder 12 drives the fixed plate 10 to rotate to expand the fixed plate, after the pressure sensor 18 reaches a set pressure, the second electric hydraulic cylinder 12 stops, the first electric hydraulic cylinder 11 drives the support plate 14 to drop and support the driving vehicle 1, after the first infrared sensor 5 detects that the distance between the center of wheel 2 and the ground is greater than the set distance, the first electric hydraulic cylinder 11 stops, at this time, the wheel 2 leaves the ground and is 4 cm away from the ground;
Step 4, the position of the drilling rig is detected by the binocular camera 31, and the initial positioning is completed, firstly, the first servo motor 21 drives the first screw 22 to rotate, so as to drive the first moving seat 23 to move on the first screw 22, and the position of the first moving seat 23 is adjusted; then the second servo motor 26 drives the second screw 27 to rotate, so as to drive the second moving seat 28 to move on the second screw 27, and the position of the second moving seat 28 is adjusted, so as to adjust the longitudinal and lateral positions of the coal powder receiving pipe 4 on the first moving seat 23 and the second moving seat 28, so that the coal powder receiving pipe 4 moves to the drilling position of the drilling rig.
Step 5, the drilling position of the drilling rig is detected again through the binocular camera 31 to complete a secondary positioning, the first servo motor 21 and the second servo motor 26 are started again to adjust the position of the coal powder receiving pipe 4, after the adjustment is completed, the third electric hydraulic cylinder 13 drive the sliding body 34 to slide forward, the sliding of the sliding body 34 drives the fixed column 32 to slide, and thus driving the whole cross double frame positioning mechanism to advance, so that the coal powder receiving pipe 4 of the coal powder inlet is close to the drilling position of the drilling rig;
Step 6, the vacuuming element 9 is started, and the coal powder enters the coal powder storage box 3 through the coal powder receiving pipe 4, the first connecting tube 7, the vacuuming element 9, and the second connecting pipe 8 in turn to complete the primary coal powder receiving.

### Embodiment 2

Different from Embodiment 1, as shown in FIG. 6, there is also a double-shaft cylinder 37 under the coal powder receiving pipe 4, the double-shaft cylinder 37 is set on the second moving seat 28 of the cross double frame positioning mechanism, the double-shaft cylinder 37 can move with the movement of the second moving seat 28 and realize the movement of forward, backward, left and right, and its position is adjusted. The cylinder rod of the double-shaft cylinder 37 is connected to one end of the collection box 38, the other end of the collection box 38 is provided with an arc opening 39, and the arc opening 39 is connected to an inclined collecting shovel 40, the collecting shovel 40 is used to collect the coal powder taken out of the drilling rig from the borehole.

In the receiving method, when the drilling rig is drilled and pulled out from the borehole, a part of the coal powder will be carried out. This part of the coal powder is collected by the inclined collecting shovel 40 and slipped into the collection box 38.

Therefore, the invention adopts the above-mentioned intelligent automatic coal powder receiving device and method based on prevention and control of rock bursts in coal mines and realizes automatic positioning and automatic receiving of coal powder through a variety of sensors and a central processor, which is more intelligent and easy to operate, the labor costs are reduced and the safety of workers is guaranteed, it is more convenient.

Finally, it should be explained that the above embodiments are only used to explain the technical scheme of the invention rather than restrict it. Although the invention is described in detail concerning the better embodiment, the ordinary technical personnel in this field should understand that they can still modify or replace the technical scheme of the invention, and these modifications or equivalent substitutions cannot make the modified technical scheme out of the spirit and scope of the technical scheme of the invention.

What is claimed is:

1. An intelligent automatic coal powder receiving device based on prevention and control of rock bursts in coal mines, comprising a driving vehicle, wherein wheels with a moving function are set on the driving vehicle, a central processor is set in the driving vehicle, supporting mechanisms with a flipping and retracting function are set symmetrically on both sides of the driving vehicle, a coal powder storage box and a cross double frame positioning mechanism are set at a top of the driving vehicle, a coal powder receiving pipe is set on the cross double frame positioning mechanism, a binocular camera is set at the coal powder receiving pipe, and a first end of the coal powder receiving pipe is a coal powder inlet, a second end of the coal powder receiving pipe is connected to the coal powder storage box through a connecting pipe, and the cross double frame positioning mechanism is connected to the driving vehicle through a telescopic mechanism.

2. The intelligent automatic coal powder receiving device according to claim 1, wherein a center of each of the wheels is provided with a first infrared sensor, the first infrared sensor is configured to detect a distance between a wheel center and ground; the connecting pipe comprises a first connecting pipe and a second connecting pipe, the first connecting pipe is a hose, a first end of the first connecting pipe is connected to the coal powder receiving pipe, a second end of the first connecting pipe is connected to a vacuuming element, and the vacuuming element is connected to an interior of the coal powder storage box through the second connecting pipe.

3. The intelligent automatic coal powder receiving device according to claim 1, wherein the supporting mechanism comprises a fixed plate, a top of the fixed plate is provided with a first electric hydraulic cylinder, a hydraulic rod of the first electric hydraulic cylinder runs through the fixed plate and connects to a top of a support plate, a side of the fixed plate is connected to a side of the driving vehicle, and the fixed plate is connected to the top of the driving vehicle through a rotating structure.

4. The intelligent automatic coal powder receiving device according to claim 3, wherein both ends of the fixed plate and front and rear ends of the driving vehicle are equipped with a sensor box, the sensor box is equipped with a visual sensor, the sensor box is equipped with a second infrared sensor, the visual sensor is configured to detect an obstacle at the front and rear ends and left and right sides of the driving vehicle, and the second infrared sensor is configured to detect a distance between the driving vehicle and the obstacle.

5. The intelligent automatic coal powder receiving device according to claim 3, wherein the rotating structure comprises a fixed block set at the top of the driving vehicle, and a second electric hydraulic cylinder is set on the fixed block, a hydraulic rod of the second electric hydraulic cylinder is hinged with the top of the fixed plate, and a bottom of the second electric hydraulic cylinder is hinged with the fixed block, pressure sensors are arranged on the both sides of the driving vehicle corresponding to a position of the fixed plate, and each of the pressure sensors is configured to detect a pressure between the fixed plate and the driving vehicle.

6. The intelligent automatic coal powder receiving device according to claim 1, wherein the cross double frame positioning mechanism comprises a first frame and a second frame, four corners of the first frame are connected to four corners of the second frame through a connecting column, the first frame is connected to the telescopic mechanism through a fixed column, the first frame is equipped with a longitudinal movement adjustment structure, and the second frame is equipped with a lateral movement adjustment structure.

7. The intelligent automatic coal powder receiving device according to claim 6, wherein the longitudinal movement adjustment structure comprises two first screws, the first screw is sleeved with a first moving seat, the second end of the coal powder receiving pipe is arranged on the first moving seat, the first screw is connected to the first moving seat through a first thread, a top of the first frame is provided with an upper opening, a bottom of the first frame is provided with a lower opening, a first sliding seat is movably set in the upper opening, a second sliding seat is movably set in the lower opening, a first servo motor is provided on the first sliding seat, an output shaft of the first servo motor is connected to a first end of the first screw, and a second end of the first screw is in a rotary connection with the second sliding seat;
the lateral movement adjustment structure comprises two second screws, the second screw is sleeved with a second moving seat, the first end of the coal powder receiving pipe is set on the second moving seat, the second screw is connected to the second moving seat through a second thread, a first side of the first frame is provided with a left opening, and a second side of the first frame is provided with a right opening, a third sliding seat is movably set in the left opening, a fourth sliding seat is movably set in the right opening, a second servo motor is provided on the third sliding seat, an output shaft of the second servo motor is connected to a first end of the second screw, and a second end of the second screw is in the rotary connection with the fourth sliding seat; and the binocular camera is set on the second moving seat.

8. The intelligent automatic coal powder receiving device according to claim 5, wherein the telescopic mechanism comprises a sliding body set on the driving vehicle, and a lower part of the sliding body is slidingly connected to an inner side of the fixed block, the coal powder storage box is equipped with a third electric hydraulic cylinder, and a hydraulic cylinder rod of the third electric hydraulic cylinder is connected to an end of the sliding body.

9. The intelligent automatic coal powder receiving device according to claim 1, wherein a double-shaft cylinder is arranged below the coal powder receiving pipe, and the double-shaft cylinder is arranged on the cross double frame positioning mechanism, a cylinder rod of the double-shaft cylinder is connected to a first end of a collection box, a second end of the collection box is provided with an arc opening, the arc opening is connected with an inclined collecting shovel, and the inclined collecting shovel is configured to collect coal powder extracted from a drilling rig.

10. A receiving method for the intelligent automatic coal powder receiving device according to claim 1, comprising the following steps:
step 1, driving the driving vehicle to a target location by the wheels, and using a visual sensor and a second infrared sensor to avoid obstacles during a movement;
step 2, detecting a distance between the driving vehicle and a drilling position of a drilling rig by the second infrared sensor and the binocular camera, and adjusting a position of the driving vehicle;
step 3, after the position of the driving vehicle is well adjusted, driving a fixed plate to rotate by a second electric hydraulic cylinder to expand the fixed plate, after a pressure sensor reaches a set pressure, stopping the second electric hydraulic cylinder, driving a support plate to drop by a first electric hydraulic cylinder to support the driving vehicle, after a first infrared sensor detects that a distance between a wheel center and ground is greater than a set distance, stopping the first electric hydraulic cylinder;
step 4, detecting the drilling position of the drilling rig by the binocular camera to complete an initial positioning, firstly, driving a first screw to rotate by a first servo motor to drive a first moving seat to move on the first screw and adjust a position of the first moving seat; then driving a second screw to rotate by a second servo motor to drive a second moving seat to move on the second screw and adjust a position of the second moving seat, to adjust a longitudinal position and a lateral position of the coal powder receiving pipe on the first moving seat and the second moving seat, wherein the coal powder receiving pipe moves to the drilling position of the drilling rig;
step 5, detecting the drilling position of the drilling rig again through the binocular camera to complete a secondary positioning, starting the first servo motor and the second servo motor again to adjust a position of the coal powder receiving pipe, after an adjustment is completed, driving a sliding body to slide forward by a third electric hydraulic cylinder, driving a fixed column to slide by the sliding body, and then driving the cross double frame positioning mechanism to advance, wherein the coal powder inlet of the coal powder receiving pipe is adjacent to the drilling position of the drilling rig; and
step 6, starting a vacuuming element, and allowing coal powder to enter the coal powder storage box through the coal powder receiving pipe, a first connecting pipe, the vacuuming element, and a second connecting pipe in turn to complete a coal powder receiving.

11. The receiving method according to claim 10, wherein in the intelligent automatic coal powder receiving device, a center of each of the wheels is provided with the first infrared sensor, the first infrared sensor is configured to detect the distance between the wheel center and the ground; the connecting pipe comprises the first connecting pipe and the second connecting pipe, the first connecting pipe is a hose, a first end of the first connecting pipe is connected to the coal powder receiving pipe, a second end of the first connecting pipe is connected to the vacuuming element, and the vacuuming element is connected to an interior of the coal powder storage box through the second connecting pipe.

12. The receiving method according to claim 10, wherein in the intelligent automatic coal powder receiving device, the supporting mechanism comprises the fixed plate, a top of the fixed plate is provided with the first electric hydraulic cylinder, a hydraulic rod of the first electric hydraulic cylinder runs through the fixed plate and connects to a top of the support plate, a side of the fixed plate is connected to a side of the driving vehicle, and the fixed plate is connected to the top of the driving vehicle through a rotating structure.

13. The receiving method according to claim 12, wherein in the intelligent automatic coal powder receiving device, wherein both ends of the fixed plate and front and rear ends of the driving vehicle are equipped with a sensor box, the sensor box is equipped with the visual sensor, the sensor box is equipped with the second infrared sensor, the visual sensor is configured to detect the obstacle at the front and rear ends and left and right sides of the driving vehicle, and the second infrared sensor is configured to detect a distance between the driving vehicle and the obstacle.

14. The receiving method according to claim 12, wherein in the intelligent automatic coal powder receiving device, wherein the rotating structure comprises a fixed block set at the top of the driving vehicle, and the second electric hydraulic cylinder is set on the fixed block, a hydraulic rod of the second electric hydraulic cylinder is hinged with the top of the fixed plate, and a bottom of the second electric hydraulic cylinder is hinged with the fixed block, the pressure sensors are arranged on the both sides of the driving vehicle corresponding to a position of the fixed plate, and each of the pressure sensors is configured to detect a pressure between the fixed plate and the driving vehicle.

15. The receiving method according to claim 10, wherein in the intelligent automatic coal powder receiving device, the cross double frame positioning mechanism comprises a first frame and a second frame, four corners of the first frame are connected to four corners of the second frame through a connecting column, the first frame is connected to the telescopic mechanism through the fixed column, the first frame is equipped with a longitudinal movement adjustment structure, and the second frame is equipped with a lateral movement adjustment structure.

16. The receiving method according to claim 15, wherein in the intelligent automatic coal powder receiving device, the longitudinal movement adjustment structure comprises two first screws, the first screw is sleeved with the first moving seat, the second end of the coal powder receiving pipe is arranged on the first moving seat, the first screw is connected to the first moving seat through a first thread, a top of the first frame is provided with an upper opening, a bottom of the first frame is provided with a lower opening, a first sliding seat is movably set in the upper opening, a second sliding seat is movably set in the lower opening, the first servo motor is provided on the first sliding seat, an output shaft of the first servo motor is connected to a first end of the first screw, and a second end of the first screw is in a rotary connection with the second sliding seat;
the lateral movement adjustment structure comprises two second screws, the second screw is sleeved with the second moving seat, the first end of the coal powder receiving pipe is set on the second moving seat, the second screw is connected to the second moving seat through a second thread, a first side of the first frame is provided with a left opening, and a second side of the first frame is provided with a right opening, a third sliding seat is movably set in the left opening, a fourth sliding seat is movably set in the right opening, the second servo motor is provided on the third sliding seat, an output shaft of the second servo motor is connected to a first end of the second screw, and a second end of the second screw is in the rotary connection with the fourth sliding seat; the binocular camera is set on the second moving seat.

17. The receiving method according to claim 14, wherein in the intelligent automatic coal powder receiving device, the telescopic mechanism comprises the sliding body set on the driving vehicle, and a lower part of the sliding body is slidingly connected to an inner side of the fixed block, the coal powder storage box is equipped with the third electric hydraulic cylinder, and a hydraulic cylinder rod of the third electric hydraulic cylinder is connected to an end of the sliding body.

18. The receiving method according to claim 10, wherein in the intelligent automatic coal powder receiving device, a double-shaft cylinder is arranged below the coal powder receiving pipe, and the double-shaft cylinder is arranged on the cross double frame positioning mechanism, a cylinder rod of the double-shaft cylinder is connected to a first end of a collection box, a second end of the collection box is provided with an arc opening, the arc opening is connected with an inclined collecting shovel, and the inclined collecting shovel is configured to collect the coal powder extracted from the drilling rig.
